(19) United States
(12) Patent Application Publication
(10) Pub. No.: US 2003/0133614 A1
(43) Pub. Date: Jul. 17, 2003

(54) Image capturing device for event monitoring

(76) Inventors: Mark N. Robins, Greeley, CO (US); Heather N. Bean, Fort Collins, CO (US); Matthew Flach, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/044,026

(22) Filed: Jan. 11, 2002

(51) Int. Cl. G06K 9/68; H04N 7/18

(52) U.S. Cl. 382/219; 348/143

(57) ABSTRACT

An image capturing device includes an electronic image sensor, a memory including a frame buffer, and a processor. The processor conducts an image capture of a digital image frame and extracts predetermined events in the digital image frame.

### FIELD OF THE INVENTION

The present invention relates generally to an image capturing device such as a video camera, and more particularly to an image capturing device for event monitoring, such as a video camera used for surveillance.

### BACKGROUND OF THE INVENTION

Video cameras are electronic devices commonly used to capture images, scenes, persons, events, etc. One use for video cameras is for surveillance, wherein a video is captured and recorded for later use to determine whether an event occurred (or did not occur). Therefore, a video camera may be positioned in a location where it is desired to record an event.

In the prior art, video cameras are used for such surveillance by capturing a series of images. For example, a surveillance camera may be positioned in a business or work facility. Such surveillance may be used for a variety of settings and purposes, including, for example, monitoring work attendance, monitoring consumer behavior in retail outlets, monitoring employee hygiene and hand-washing compliance in a food handling environment, monitoring access to restricted areas, monitoring attendance numbers, etc. In all of these settings, the surveillance is used to capture specific information.

Prior art video cameras may be analog or digital. An analog camera records analog video signals onto a magnetic tape. Digital cameras record digital video signals in a solid state memory, such as a RAM or onto a magnetic tape. Recently, the trend is more use of digital video cameras.

However, the digital video surveillance of the prior art has several large drawbacks. One drawback is that the video surveillance according to the prior art records a huge amount of digital data and therefore requires a huge amount of storage space. A VGA quality digital video requires approximately 25 to 100 kilobytes of data per image frame. Multiple frames per second are typically captured for a video. It may even be desirable to use a higher resolution sensor to gather enough information to be useful in some types of events. However, as a general rule, the storage of more than 1 megabyte of frame files is impractically expensive for a surveillance device. Even in analog cameras, large numbers of videotapes must be used to store many hours of surveillance, even when nothing is happening.

Another drawback is that the desired surveillance data may be buried in a lot of accumulated images. Therefore, the accumulated digital image data must be sifted in order to determine whether any desired events have been captured and before the events themselves can be analyzed.

Another drawback is that such data sifting is typically manual in nature. The prior art approach therefore requires a large amount of man hours and associated cost. For example, a person must review a video surveillance recording in order to detect whether certain desired events have or have not occurred. Then the actual event may be analyzed. For example, the number of occurrences of an event may be counted.

Yet another problematic feature of video surveillance according to the prior art is that it presents privacy issues. In many settings, people have some expectations of privacy. Consequently, people do not like to be filmed without their knowledge and consent; especially in areas like restrooms, as in the hand washing example above. Therefore, they may object to video surveillance, especially in work environments, for example, where people do not want to have their every move monitored.

Therefore, there remains a need in the art for improvements in surveillance.

### SUMMARY OF THE INVENTION

An image capturing device comprises an electronic image sensor, a memory including a frame buffer, and a processor. The processor conducts an image capture of a digital image frame and extracts predetermined events in the digital image frame.

### BRIEF DESCRIPTION OF THE DRAWINGS

FIG. 1 shows an image capturing device according to one embodiment of the invention;

FIG. 2 is a flowchart of an event monitoring process according to another embodiment of the invention; and

FIG. 3 is a flowchart of an event monitoring process according to another embodiment of the invention.

### DETAILED DESCRIPTION

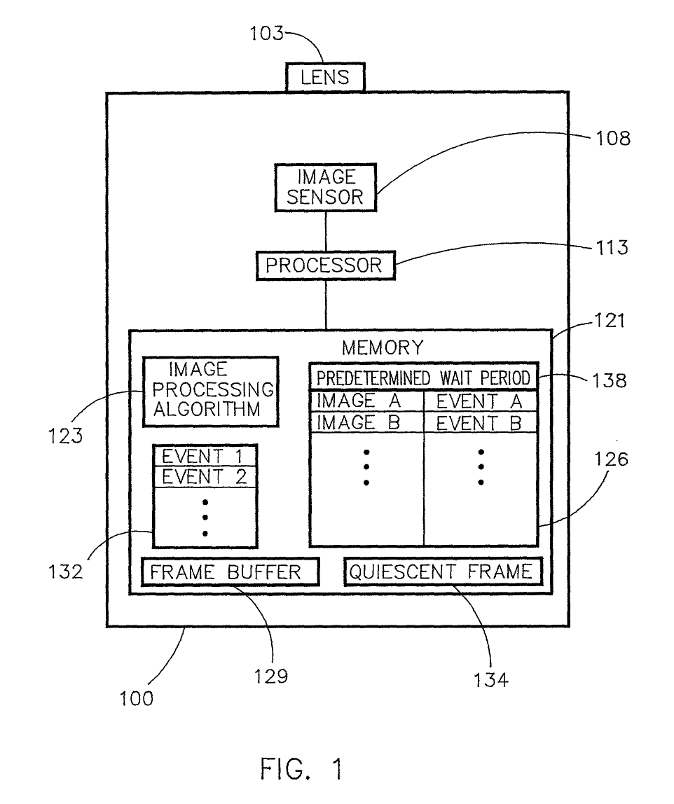

FIG. 1 shows an image capturing device 100 according to one embodiment of the invention. The image capturing device 100 includes a lens 103, an image sensor 108, a processor 113, and a memory 121.

The image sensor 108 may be any type of electronic image sensor capable of capturing a series of digital images, such as a charge coupled device (CCD) sensor or a complementary metal oxide semiconductor (CMOS) sensor, for example. The image sensor 108 may capture multiple frames, with each frame being captured at a predetermined time interval.

According to the invention, the image sensor 108 may not need to capture frames as frequently as a typical video camera. For example, a digital still image may be captured about every second and may provide sufficient data to provide event monitoring (other wait periods may be used). This is in contrast to a video signal, which captures about 20 to 24 frames per second in order to capture realistic (i.e., continuous) motion. It should be understood, however, that the image capturing device 100 may alternatively capture and process a video signal, with only a portion of the video signal being retained in the frame buffer 129.

The processor 113 may be any type of general purpose processor. The processor 113 executes a control routine (not shown) contained in the memory 121. In addition, the processor 113 receives inputs, controls capture of digital image frames, and extracts events from the captured digital image frames.

The memory 121 may be any type of digital memory. The memory 121 may include, among other things, an optional image processing algorithm 123, a frame buffer 129, an optional object-to-event mapping table 126, an optional event storage area 132, an optional quiescent frame 134, and a predetermined wait period storage area 138. In addition, the memory 121 may store software or firmware to be executed by the processor 113 for operation of the image capturing device 100.

The frame buffer 129 may be any type of buffer. The frame buffer 129 may hold one or more captured digital image frames. In one embodiment, the frame buffer 129 may be a circular buffer such as a first-in, first-out (FIFO) shift register, wherein a newest digital image frame replaces an oldest digital image frame within the frame buffer 129.

The optional event storage 132 may be used to store recognized events extracted from an image or images. For example, the event storage 132 may store the occurrence of a door opening, the presence of a person, a light being turned on or off, etc. The stored data may be a symbol or code that represents the corresponding event, and may be later interpreted and expanded upon in order to generate a report or other output.

The predetermined wait period 138 may be a time period value that controls the elapsed time between image captures. The predetermined wait period 138 therefore controls the frequency of the image capture operation, and may be chosen in order to sufficiently monitor events in real time and yet minimize the storage space and processing time requirements.

The optional image processing algorithm 123 may be any type of image processing algorithm capable of recognizing objects within a digital image frame. The image processing algorithm 123 may include a library of objects that may be detected in an image frame. The library of objects may be selected according to the intended event monitoring use of the image capturing device 100. The image processing algorithm 123 may recognize an object by optically identifying edges or borders within the image, such as by recognizing the linear and well-defined edges of a door, for example.

The object-to-event mapping table 126 may be used by the image processing algorithm 123 and may be used to map a recognized object to an event. For example, if the image processing algorithm 123 recognizes a rectangular object or border in the image, the object-to-event mapping table 126 may be used to map that object to the occurrence of a door opening. This may include comparison to various sizes of rectangles to determine when the door has opened far enough to actually be considered to have opened, i.e., the door opening by just a crack may not be considered to be a door opening event.

The quiescent frame 134 may store a quiescent digital image. The quiescent frame 134 is captured when the region for the image to be captured is quiescent, i.e., it is in a quiet or undisturbed state. This quiescent frame 134 may serve as a comparison frame that is used to determine when an event has occurred, with an event being any non-quiescent image.

In operation, the image sensor 108 captures one or more digital image frames (i.e., a video signal or a plurality of still images). The processor 113 receives the digital image frames in the frame buffer 129 and processes them according to the algorithm 123 and the quiescent frame 134, together with the event mapping table 126, in order to detect the occurrence of any events within the captured image frames. The detected events may be acted upon (such as the generation of an alarm output or control output) or may be stored for later use (such as in the event storage 132).

The captured image frames advantageously may be discarded after the events are extracted. However, the extracted events first may be recorded in some fashion, such as being stored in an event storage 132 in a sequential or non-sequential fashion. The image capturing device 100 may occasionally transfer the stored data to other external devices or form some manner of report that outlines the events that have occurred. The image capturing device 100 may optionally store a time stamp (not shown) for each event in the event storage 132.

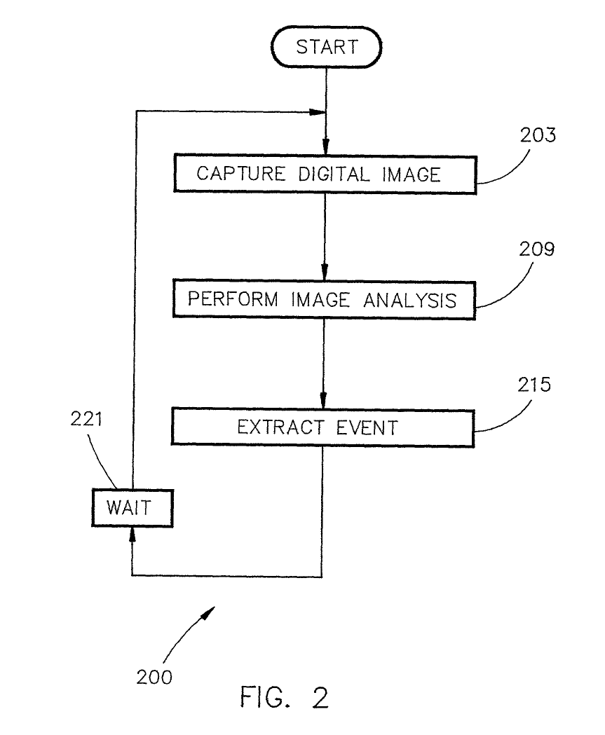

FIG. 2 is a flowchart 200 of an event monitoring process according to another embodiment of the invention. In step 203, a digital image is captured, as previously discussed. This may include a single frame, a sequence of digital still images, or even a digital video signal. Because the invention processes the captured images automatically without the need for human event sifting, a series of still images captured at predetermined time intervals may be sufficient, and may therefore reduce the human processing and computer memory requirements of a surveillance device.

In step 209, an image analysis is performed on a captured digital image frame. The image capturing device 100 may employ the image processing algorithm 123 in order to detect objects in a digital image frame (held in the frame buffer 129). Each digital image frame is scanned in order to detect the presence of predetermined objects. The image processing algorithm 123 therefore may include a library of defined or predetermined objects.

In step 215, an event is extracted from the image, if an event has occurred. The event may be a presence of a person, opening of a door, use of a facility, entrance or exit of a person from a scene, etc. The event extraction may be accomplished using the object-to-event mapping table 126. The object-to-event mapping table 126 may be used for comparing detected objects to a set of defined objects within the table. The object-to-event mapping table 126 further includes a corresponding set of defined events. Consequently, an event is detected when there is a match between a found object and a corresponding object in the object-to-event mapping table 126. The detected event may be acted upon (such as the generation of an alarm or other output) or may be stored for later use (such as in the event storage 132).

In step 221, a predetermined wait period between image captures may be performed, such as by a timer, for example. After the predetermined wait period has expired, the method branches back to step 203, and another digital image frame may be captured for processing.

It should be understood that successive images may be processed and the event monitoring may be iterative and continuous. According to the invention, the frame buffer 129 may be used to store one or more digital image frames, including a digital video signal. Therefore, there is no need to store a large and continuous number of digital image frames.

The extracted non-video record of events may be acted on, or may be stored and later recalled and analyzed as desired. Of course, events need only be stored as they occur. Therefore, there is no need to store large amounts of data if events are not occurring, as is done in conventional video surveillance technology.

The stored event record may be later downloaded or transferred. The small size of the stored event record eases transfer, handling, and manipulation. Consequently, storage needs are greatly reduced over the prior art video surveillance. In addition, privacy concerns are eliminated, as a person's face or identity are not examined or stored in event records. The invention therefore may operate by recognizing basic human shapes, for example, or may operate by just recognizing a scene change.

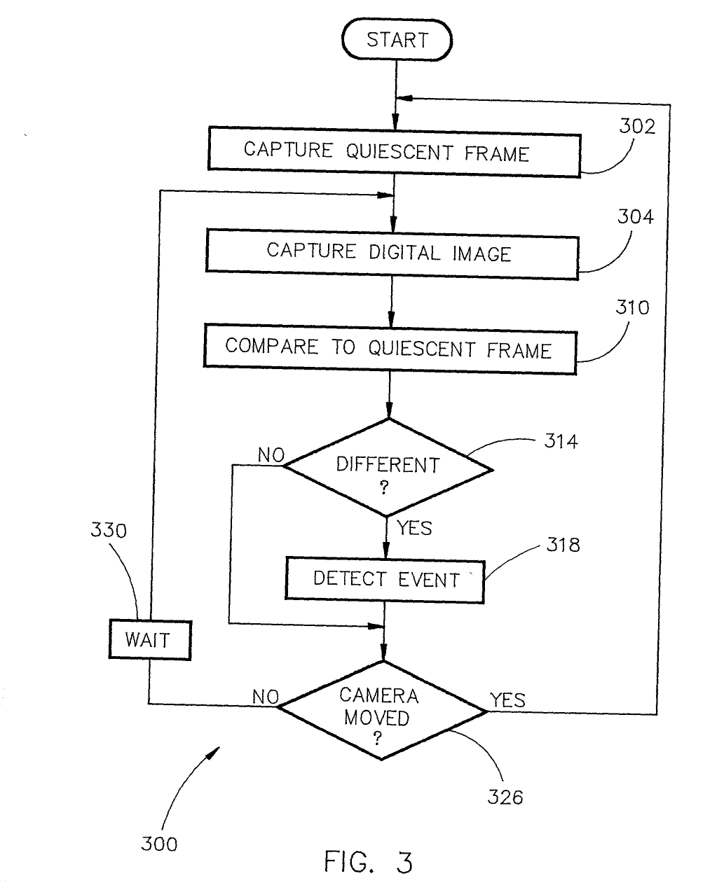

FIG. 3 is a flowchart 300 of an event monitoring process according to another embodiment of the invention. In step 302, an initial digital image frame is captured and stored in the quiescent frame 134 as a quiescent image of the scene under surveillance. This quiescent frame 134 must be captured before event monitoring can commence, and is an image of the area to be monitored when it is undisturbed and quiescent. In the restroom example given above, the initial digital image frame stored to the quiescent frame 134 may be an image of an empty restroom, with the door closed and the room unoccupied.

In step 304, a current digital image frame is captured by the image capturing device 100, as previously discussed.

In step 310, the current image frame is compared to the quiescent frame 134.

In step 314, if the current image frame is significantly different than the quiescent frame 134, the method proceeds to step 318, otherwise it proceeds to step 326. Each digital image frame comprises a plurality of digital pixel values that digitally represent portions of the image. Therefore, if the number of pixels that have changed between images exceeds a predetermined threshold value, the processor 113 may determine that the digital image frame is significantly different from the quiescent frame 134. An event is therefore detected when the digital image frame deviates significantly from the quiescent frame 134. As a result, in the simpler approach of this second method embodiment, the image processing algorithm 123 is not needed.

In step 318, because a difference has been detected, an event is therefore detected. The event that has been detected may depend on the amount of difference between the digital image frame and the quiescent frame 134, or may be a simple yes-or-no determination on the part of the image capturing device 100 (for example, either a person is detected or not). Therefore, if a change in the restroom sink view occurs (perhaps other than uniform darkening, to account for lights on and off), a sink use event may be recorded. Consequently, if a sink use event data is combined with a room use event data, the percent of the time sink use occurs per room use would be known without any sophisticated object or event recognition.

The detected events may be acted upon, such as by generating some manner of alarm output or control output, for example when a restroom use event is not followed by a sink use event. Alternatively, the detected events may be stored for later use, such as in the event storage 132, and may be later processed, analyzed, or reported. It should be noted that this embodiment may include an adjustment of the digital image frame in order to compensate for changes in lighting, so that a change in lighting alone does not trigger a detection of an event (i.e., turning off the lights will not cause another event to be detected).

In step 326, if the image capturing device 100 has been moved, the method branches back to step 302, and a new quiescent frame 134 must be captured in order to continue the event monitoring. Optionally, each time the image capturing device 100 is moved, a user interface on the image capturing device 100 may prompt the user to capture a new quiescent frame 134 for future comparisons. Otherwise, if the image capturing device 100 has not been moved, the method branches to step 330.

In step 330, a predetermined wait period between image captures may be performed, such as by a timer, for example. After the predetermined wait period has expired, the method branches back to step 304, and another digital image frame may be captured for processing.

The invention applies to any type of surveillance camera, event monitoring system, security alarm system, or process triggering system. For example, the event monitoring according to the invention may be used to trigger security alarms by detecting a presence of a human at certain times, for example. In an interactive advertising setting, the presence of a human within a predetermined range of the image capturing device 100 may trigger an interactive advertising process. In a factory setting, the occurrence of a particular event may trigger another event without the need for expensive optical recognition cameras and an associated high-processing capability computer system.

The invention differs from the prior art in that the prior art continuously captures and stores large amounts of video image data, which consumes much storage space. In addition, the prior art requires a human operator either to monitor the video image in real time or to sift through the recorded data and extract the events. This is laborious, time-consuming, and ultimately very expensive. Furthermore, the prior art records the identities and actions of persons. This may present privacy concerns or, at the very least, a sense of distrust and resentment on the part of the persons being monitored.

In contrast, the event monitoring according to the invention never requires any storage other than a buffer in memory. Furthermore, the invention only uses additional storage space when an event of interest occurs and when a recording of events is specifically desired. In addition, the invention raises very minimal privacy concerns. The invention can watch a large amount of events and gather only desired data. The events do not need to be manually sifted from a large amount of recorded data. Personal identities are not captured or recorded.

We claim:

1. An image capturing device, comprising:
an electronic image sensor;
a memory including a frame buffer storing at least one digital image frame; and
a processor, said processor communicating with said electronic image sensor and said memory, said processor conducting an image capture of a digital image frame into said frame buffer and extracting predetermined events in said digital image frame by comparing said digital image frame with a stored quiescent image frame.

2. The device of claim 1, wherein said frame buffer comprises a circular frame buffer.

3. The device of claim 1, wherein said digital image frame is discarded after said one or more events are extracted.

4. The device of claim 1, said memory further including an event storage that stores one or more events extracted from one or more digital image frames.

5. The device of claim 1, said memory further including:
an image processing algorithm that optically identifies objects in said digital image frame; and
an object-to-event mapping table including a set of defined objects and a corresponding set of defined events, with an entry of said object-to-event mapping table mapping a particular object to a particular event;
wherein said processor uses said image processing algorithm to optically identify one or more objects in said digital image frame and uses said object-to-event mapping table to extract one or more events corresponding to said one or more objects.

6. The device of claim 5, wherein said image processing algorithm further includes a library of predetermined objects, with each object in said library of predetermined objects representing a predetermined event.

7. The device of claim 1, wherein said processor compares said digital image frame to said quiescent frame and detects an event if said digital image frame is substantially different than said quiescent frame.

8. An event monitoring method, comprising the steps of:
capturing a digital image frame at a predetermined capture rate;
performing image analysis on said digital image frame;
extracting predetermined events in said digital image frame according to event data stored in a memory; and
recording the occurrence of an extracted event.

9. The method of claim 8, wherein said digital image frame is discarded after said event is extracted.

10. The method of claim 8, further comprising the step of storing said event.

11. The method of claim 8, wherein the capturing, performing, and extracting steps are iteratively performed, and further comprising the step of waiting a predetermined time period after the extracting step before performing a subsequent capturing step.

12. The method of claim 8, with the step of performing image analysis further comprising optically identifying an object in said digital image frame.

13. The method of claim 8, with the step of performing image analysis further comprising optically identifying an object in said digital image frame and with the step of extracting an event further comprising mapping said object to an event of a set of defined events.

14. The method of claim 8, wherein said processor uses an image processing algorithm to detect one or more objects in a digital image frame and uses an object-to-event mapping table to extract one or more events corresponding to said one or more objects.

15. The method of claim 8, with the step of performing image analysis further comprising the step of comparing said digital image frame to a library of predetermined objects, with each object in said library of predetermined objects representing a predetermined event.

16. An event monitoring method, comprising the steps of:
capturing a quiescent frame at a beginning of an event monitoring session;
capturing a digital image frame;
comparing said digital image frame to said quiescent frame;
determining if said digital image frame is substantially different from said quiescent frame; and
if said image frame is substantially different from said quiescent frame, identifying an event by comparing said difference with a stored plurality of predefined events.

17. The method of claim 16, wherein said digital image frame is discarded after said event is extracted.

18. The method of claim 16, further comprising the step of storing said event.

19. The method of claim 16, wherein the steps of capturing a digital image frame, comparing, and detecting are iteratively performed, and further comprising the step of waiting a predetermined time period after the detecting step before performing a subsequent capturing a digital image frame step.
